(19) United States
(12) Patent Application Publication
(10) Pub. No.: US 2024/0233005 A1
(43) Pub. Date: Jul. 11, 2024

(54) INTEREST TOKEN PROCESSING SYSTEM INTEGRATED WITH BLOCKCHAIN AND METHOD THEREOF

(71) Applicant: Skychain CO., LTD., Taipei City (TW)

(72) Inventors: Chen-Hsuan WANG, Taipei City (TW); Jiann-Min YANG, Taipei City (TW); Scott MIAU, Taipei City (TW)

(21) Appl. No.: 18/095,543

(22) Filed: Jan. 11, 2023

(51) Int. Cl. G06Q 40/02; G06Q 20/36

(52) U.S. Cl. CPC G06Q 40/02; G06Q 20/3672; G06Q 2220/00

(57) ABSTRACT

An interest token processing system integrated with blockchain and method thereof are disclosed. In the interest token processing system, a smart contract is deployed in blockchain environment, and interest tokens of a product or a service and a recycling condition of the interest tokens are generated for a specified target; when the product or the service is obtained through the interest tokens, the smart contract is executed to realize a part of the interest tokens based on the recycling condition and receive another part of the interest tokens for further distribution; during an operation of further distribution, the received interest tokens are distributed based on a ratio of a held amount of the interest tokens to a circulation amount of the interest tokens. Therefore, the technical effect of enabling the tokens to have usability and interest right can be achieved.

### BACKGROUND

### 1. Technical Field

The present invention relates to an interest token processing system and a method thereof, and particularly to an interest token processing system integrated with blockchain and a method thereof.

### 2. Related Art

In recent years, with the popularity and vigorous development of blockchain technology, various applications of tokens are rapidly developed.

Generally speaking, common tokens can be grouped into utility tokens and security tokens; the utility token is similar to a gift certificate or a voucher, which is only the realization of a consumption right; the security token is similar to a stock, which only includes the right to distribute equity or interest. However, currently, there is no operating mechanism that has the above-mentioned functions to enable the token to have usability and interest right; that is, all stakeholders are permitted to obtain the income rights based on a prescribed rule and also use the tokens for consumption. Therefore, the conventional token system has a problem that it is difficult to enable a token to have both of usability and interest distribution function.

According to above-mentioned contents, what is needed is to develop an improved solution to solve the conventional problems that it is difficult to enable a token to have both of usability and interest distribution function.

### SUMMARY

An objective of the present invention is to disclose an interest token processing system integrated with blockchain and a method thereof, to solve the conventional problem.

In order to achieve the objective, the present invention provides an interest token processing system integrated with blockchain. The interest token processing system is applied to blockchain environment where node hosts are disposed, each of the node hosts has a wallet address as node identification and has the ability to access a blockchain wallet according to the wallet address, and the interest token processing system includes an issuer-end node, a holder-end node and a user-end node. The issuer-end node is one of the node hosts, and the issuer-end node is configured to deploy an interest token processing contract in the blockchain environment, the interest token processing contract comprises a transfer module, an issuance module, a recycling module, a distribution module and a realization module executed by a processor, and the issuer-end node executes the issuance module to generate at least one interest token corresponding to a product or a service, and executes the recycling module to set a recycling condition of the interest token. The holder-end node is one of the node hosts, and the holder-end node is configured to hold the interest token. The user-end node is one of the node hosts, and when the user-end node wants to obtain the product or the service, the user-end node executes the recycling module to transfer the interest token corresponding to the product or service to the interest token processing contract, wherein the recycling module performs a recycling-and-splitting process on the interest token based on the recycling condition, the recycling-and-splitting process executes at least one of the realization module and the distribution module based on the recycling condition, when the realization module is executed, the realization module destroys the received interest token, wherein when the distribution module is executed, the distribution module continuously accumulates the received interest token as a to-be-distributed interest token for further distribution. When wanting to distribute the to-be-distributed interest token, the holder-end node or the issuer-end node triggers the distribution module based on the recycling condition, so that the distribution module distributes the accumulated to-be-distributed interest token to the holder-end node based on a ratio of a held amount of the at least one interest token to a current circulation amount of the at least one interest token.

In order to achieve the objective, the present invention discloses an interest token processing method integrated with blockchain. The interest token processing method is applied to blockchain environment where node hosts are disposed, each of the node hosts has a wallet address as node identification and has the ability to access a blockchain wallet according to the wallet address, and the interest token processing method includes steps of: providing an issuer-end node, a holder-end node and a user-end node as the node hosts in the blockchain environment, and deploying an interest token processing contract in the blockchain environment, wherein the interest token processing contract comprises a transfer module, an issuance module, a recycling module, a distribution module and a realization module executed by a processor; executing the issuance module to generate at least one interest token corresponding to a product or a service, transmitting the interest token to the holder-end node, and executing the recycling module to set a recycling condition of the interest token, by the issuer-end node; when the holder-end node wants to obtain the product or the service, making the holder-end node become the user-end node to execute the recycling module to transfer the interest token corresponding to the product or the service to the interest token processing contract, wherein the recycling module performs a recycling-and-splitting process on the interest token based on the recycling condition, the recycling-and-splitting process executes at least one of the realization module and the distribution module based on the recycling condition, wherein when the realization module is executed, the realization module destroys the received interest token, wherein when the distribution module is executed, the distribution module continuously accumulates the received interest token as a to-be-distributed interest token for further distribution; in order to distribute the to-be-distributed interest token, triggering the distribution module based on the recycling condition, by the holder-end node or the issuer-end node, wherein the distribution module distributes the accumulated to-be-distributed interest token to the holder-end node based on a ratio of a held amount of the at least one interest token to a current circulation amount of the at least one interest token.

According to the above-mentioned system and method of the present invention, the difference between the present invention and the conventional technology is that, in the present invention, the smart contract is deployed in the blockchain environment, and the interest tokens of the product or the service and the recycling condition of the interest tokens are generated for the specified target; when the product or the service is obtained through the interest tokens, the smart contract is executed to realize a part of the interest tokens based on the recycling condition and receive another part of the interest tokens for further distribution; during an operation of further distribution, the received interest tokens are distributed based on the ratio of the held amount of the interest tokens to the circulation amount of the interest tokens. Therefore, the technical effect of enabling the tokens to have usability and interest right can be achieved.

### BRIEF DESCRIPTION OF THE DRAWINGS

The structure, operating principle and effects of the present invention will be described in detail by way of various embodiments which are illustrated in the accompanying drawings.

FIG. 1 is a block diagram of an interest token processing system integrated with blockchain, according to the present invention.

FIGS. 2A and 2B are a flowchart of an interest token processing method integrated with blockchain, according to the present invention.

FIG. 3 is a schematic diagram of an operation of deploying an interest token processing contract in blockchain environment, according to the present invention.

FIG. 4 is a schematic diagram of an operation of generating interest tokens, according to application of the present invention.

FIG. 5 is a schematic diagram of an operation of using interest tokens, according to an application of the present invention.

FIG. 6 is a schematic diagram of an operation of distributing interest tokens, according to an application of the present invention.

FIG. 7 is a schematic diagram of an operation of transferring interest tokens, according to an application of the present invention.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

Before illustration of an interest token processing system integrated with blockchain and a method thereof of the present invention, the terms defined in the present invention are described. In the present invention, the term “interest token processing contract” means a smart contract deployed in blockchain environment and configured to process interest tokens; the term “interest token” means a utility token capable of generating interest. In practice, a smart contract means a computer program for driving execution commands based on a predetermined condition and transferred information, and particularly, the smart contract is programmed with programming language, such as Solidity, Serpent, LLL, EtherScript, or Sidechain, and the smart contract can include different functions, events and parameter states. For example, an Ethereum smart contract is compiled to obtain binary codes and an application binary interface (ABI), so as to broadcast the smart contract to the blockchain network and wait for a miner to deploy the smart contract in the blockchain to obtain a corresponding address, and so far the smart contract is deployed through the blockchain transaction. Next, each node can execute the smart contract based on the corresponding address, and change a state of the smart contract in the blockchain by different command and detect whether an event is triggered.

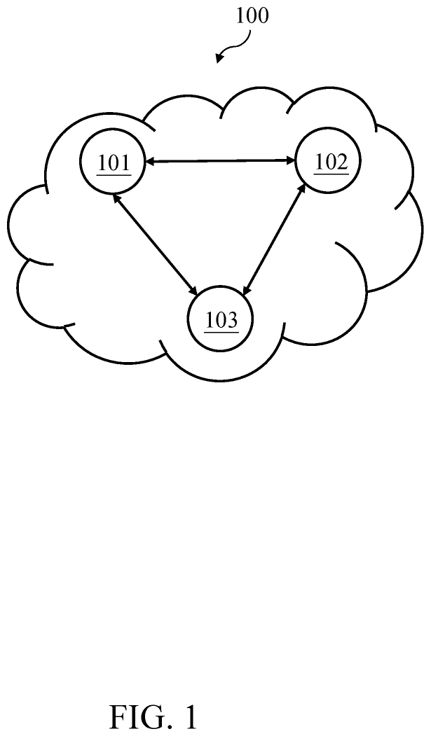

Please refer to FIG. 1, which is a block diagram of an interest token processing system integrated with blockchain, according to the present invention. The interest token processing system is applied to blockchain environment 100 where node hosts are disposed, each of the node hosts has a wallet address as node identification and has the ability to access a blockchain wallet according to the wallet address, and includes an issuer-end node 101, a holder-end node 102, and a user-end node 103. The issuer-end node 101 is one of the node hosts in the blockchain environment 100, and configured to deploy an interest token processing contract in the blockchain environment 100; for example, the interest token processing contract includes a transfer module, an issuance module, a recycling module, a distribution module, and a realization module executed by a processor. The issuer-end node 101 executes the issuance module to generate interest tokens corresponding to a product or a service, and executes the recycling module to set a recycling condition of the interest tokens. In actual implementation, when the issuer-end node 101 generates the interest tokens, the issuer-end node is permitted to set a specified amount and a specified target, to transmit the interest tokens of the specified amount to the specified target, so as to make the specified target become the holder-end node 102.

The holder-end node 102 is one of the node hosts in the blockchain environment 100, and configured to hold the interest tokens. In actual implementation, an amount of the holder-end node 102 can be single or multiple, and the holder-end node 102 is able to execute the transfer module to transfer the interest tokens to another host (such as the issuer-end node 101, the user-end node 103, or another holder-end node) in the blockchain environment 100. It is to be particularly noted that a node holding the interest token can be regarded as the holder-end node 102; in other words, the issuer-end node 101 or the user-end host 103 is the holder-end node 102 when holding the interest tokens. In actual implementation, the transmission between nodes in the blockchain environment 100 can be implemented by wired or wireless manner; for example, transmission medium of the wired manner can be copper conductive wire, coaxial cable, fiber, dual twisted wire or the like. Transmission medium of the wireless manner can be radio wave, microwave, infrared, laser or the like.

The user-end node 103 is one of the node hosts in the blockchain environment 100. In order to obtain the product or the service, the user-end node 103 executes the recycling module to transfer the at least one interest token corresponding to the product or the service to an interest token processing contract, the recycling module performs a recycling-and-splitting process on the at least one interest token based on the recycling condition; the recycling-and-splitting process executes at least one of the realization module and the distribution module based on the recycling condition; for example, when the realization module is executed, the realization module destroys the received interest token; when the distribution module is executed, the distribution module continuously accumulates the received interest tokens as to-be-distributed interest tokens for further distribution. In actual implementation, an amount of the user-end node 103 can be single or multiple, the distribution module can include a time interval for every distribution; for example, the distribution can be performed every five minutes. The distribution module is permitted to be executed by the holder-end node 102 that holds the interest tokens of amount satisfying a preset value, or the distribution module is permitted to be only executed by a specified target (such as the issuer-end node 101, the holder-end node 102 or the user-end node 103) within a specified time range.

In order to distribute the to-be-distributed interest tokens, the holder-end node 102 or the issuer-end node 101 can trigger the distribution module based on the recycling condition, so that the distribution module distributes the accumulated to-be-distributed interest tokens to the holder-end node 102 based on a ratio of a held amount of the interest tokens to a current circulation amount of the interest tokens. For example, when the ratio of the held amount to the current circulation amount is 20%, it indicates that 20% of the accumulated to-be-distributed interest tokens are distributed to the corresponding holder-end node 102. In actual implementation, the current circulation amount is equal to a total issuance amount minus a total realization amount.

It is to be particularly noted that, in actual implementation, the functions of the present invention can be implemented by various manners, including software, hardware or any combination thereof, for example, in an embodiment, the functions can be implemented by software and hardware, or one of software and hardware. Furthermore, the present invention can be implemented fully or partly based on hardware, for example, one or more function of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus. Computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, an RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as optical signal transmitted through fiber cable), or electric signal transmitted through electric wire. Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C #, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

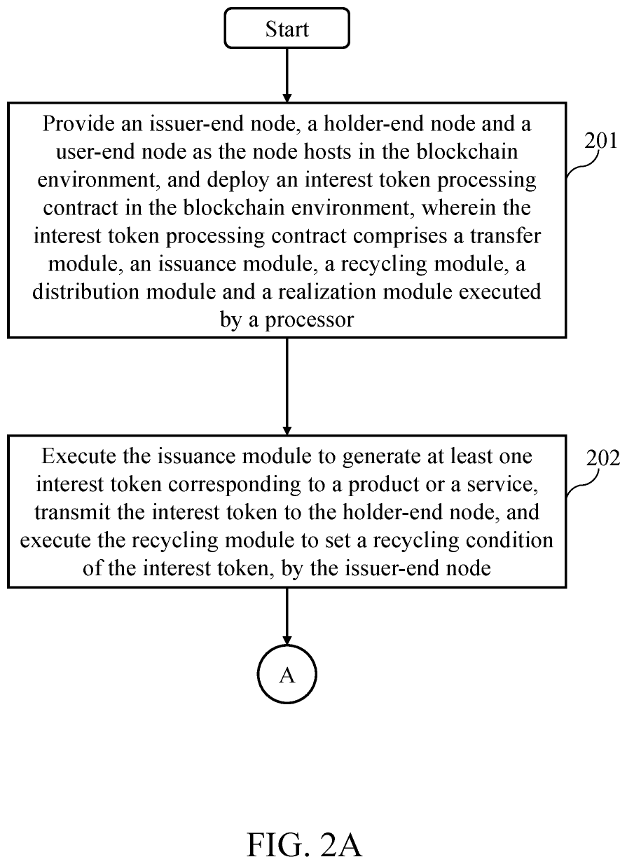

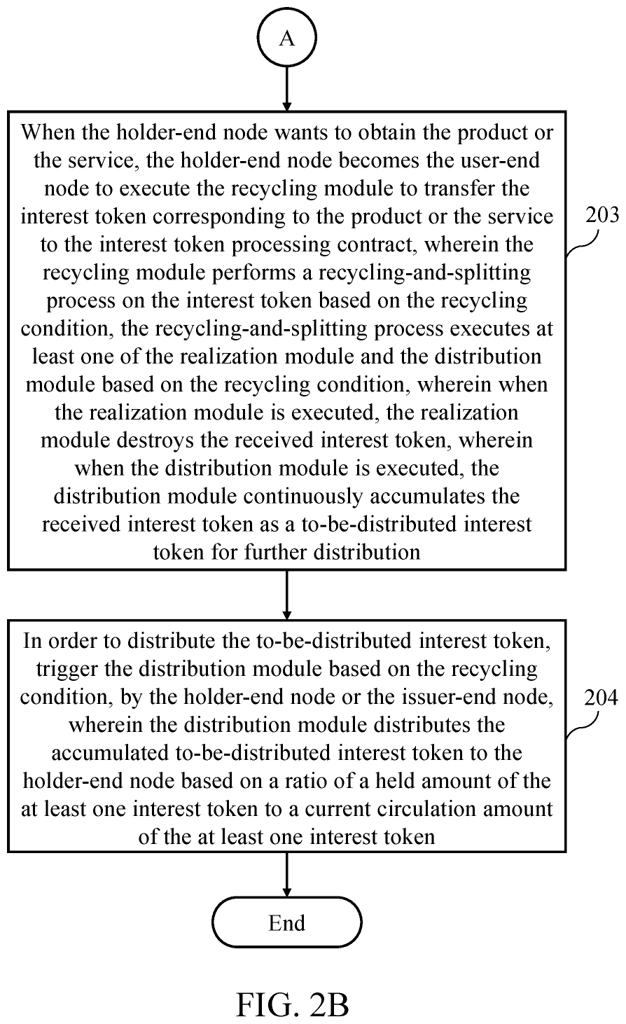

Please refer to FIGS. 2A and 2B, which are a flowchart of an interest token processing method integrated with blockchain, according to the present invention. The interest token processing method is applied to blockchain environment where node hosts are disposed, each of the node hosts has a wallet address as node identification and has the ability to access a blockchain wallet according to the wallet address, and includes the following steps. In a step 201, an issuer-end node 101, a holder-end node 102 and a user-end node 103 are provided as the node hosts in the blockchain environment 100, and an interest token processing contract is deployed in the blockchain environment 100, wherein the interest token processing contract includes a transfer module, an issuance module, a recycling module, a distribution module and a realization module executed by a processor. In a step 202, the issuer-end node 101 executes the issuance module is executed to generate at least one interest token corresponding to a product or a service, transmits the interest token to the holder-end node 102, and executes the recycling module to set a recycling condition of the interest token. In a step 203, when the holder-end node 102 wants to obtain the product or the service, the holder-end node 102 becomes the user-end node 103 to execute the recycling module to transfer the interest token corresponding to the product or the service to the interest token processing contract, wherein the recycling module performs a recycling-and-splitting process on the interest token based on the recycling condition, the recycling-and-splitting process executes at least one of the realization module and the distribution module based on the recycling condition, wherein when the realization module is executed, the realization module destroys the received interest token, wherein when the distribution module is executed, the distribution module continuously accumulates the received interest token as a to-be-distributed interest token for further distribution. In a step 204, in order to distribute the to-be-distributed interest token, the holder-end node 102 or the issuer-end node 101 can trigger the distribution module based on the recycling condition, wherein the distribution module distributes the accumulated to-be-distributed interest token to the holder-end node 102 based on a ratio of a held amount of the at least one interest token to a current circulation amount of the at least one interest token. Therefore, the smart contract can be deployed in the blockchain environment 100, and the interest tokens of the product or the service and the recycling condition of the interest tokens are generated for the specified target; when the product or the service is obtained through the interest tokens, the smart contract is executed to realize a part of the interest tokens based on the recycling condition and receive another part of the interest tokens for further distribution; during an operation of further distribution, the received interest tokens are distributed based on the ratio of the held amount of the interest tokens to the circulation amount of the interest tokens. In further distribution, the to-be-distributed interest tokens are distributes based on a ratio of a held amount of the interest tokens to a circulation amount of the interest tokens.

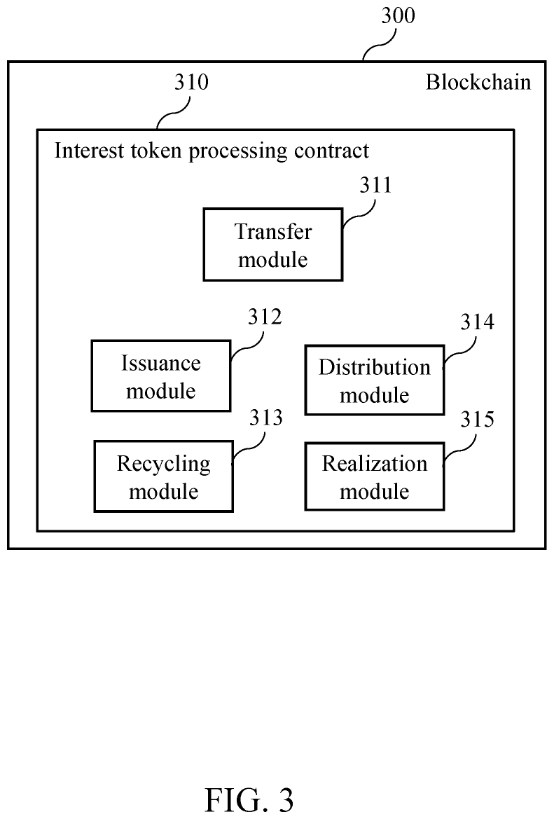

The embodiments of the present invention will be illustrated with reference to FIGS. 3 to 7 in the following paragraphs. Please refer to FIG. 3, which is a schematic diagram of an operation of deploying an interest token processing contract in blockchain environment, according to the present invention. In actual implementation, the interest token processing contract 310 completely deployed exists in a blockchain 300 of each host, the interest token processing contract 310 can include a transfer module 311, an issuance module 312, a recycling module 313, a distribution module 314, and a realization module 315 executed by a processor. The transfer module 311 has a holder relationship recording function and a transfer module of a general interest token. The issuance module 312 is configured to generate interest tokens corresponding to a product or a service. The recycling module 313 is configured to set a recycling condition of the interest tokens, such as a recycling amount, a recycling time or an upper recycling limit, a ratio of the recycled tokens to be realized or accumulated; in an embodiment, different recycling conditions can be set for different recycling requirements in different recycling operations; for example, different recycling conditions can be set for the tokens of different batches of vouchers. In actual implementation, various recycling conditions can exist at the same time; when the interest token is used, the recycling condition matching the product or service to be used can be selected, for example, for vouchers from the same department store, different realization ratio can be set for products of different counters or products of different types when the vouchers are recycled for sale of the products. The distribution module accumulates the received interest tokens as a source for sequential distribution of the interest tokens, the purpose is to encourage the interest token holders to long-term hold the interest tokens deployed by the system to obtain the to-be-distributed interest token accumulated for multiple recycling times based on a ratio of the held amount of the interest tokens to the current circulation amount of the interest tokens. It is to be particularly noted that the realization module destroys the received interest token and it means that the value of the interest token is consumed; the above-mentioned destroying manner is different from the manner of transferring the interest token to an invalid address or an eater address; in other words, the token transferred to the invalid address or the eater address is still an effectively-issued token but unable to be used, and the destroying manner of the system is to directly delete the interest token to substantially decrease the amount of the interest tokens.

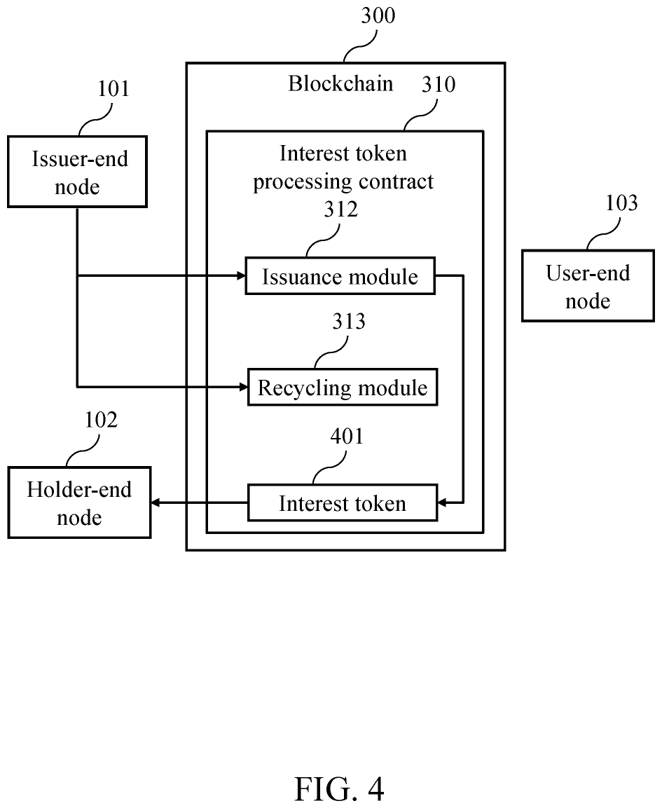

Please refer to FIG. 4, which is a schematic diagram of an operation of generating interest tokens, according to application of the present invention. In order to issue interest tokens, the issuer-end node 101 executes the issuance module 312 to generate interest tokens 401 corresponding to a product or a service, and transmits the interest tokens 401 to the holder-end node 102; for example, the issuer-end node 101 can transmit a specified amount of the interest tokens 401 to a specified target. The issuer-end node 101 can execute the recycling module 313 to set a recycling condition of the interest tokens 401, for example, the issuer-end node 101 can regulate a situation in which the user-end node 103 needs to return the interest tokens to the recycling module 313, for example, the situation can be when the user-end node 103 purchases a product or a service. In actual implementation, the number of executing the recycling module 313 is not limited to one; similarly, the number of executing the recycling module 313 is also not limited to one, and various recycling conditions can be set and exist at the same time.

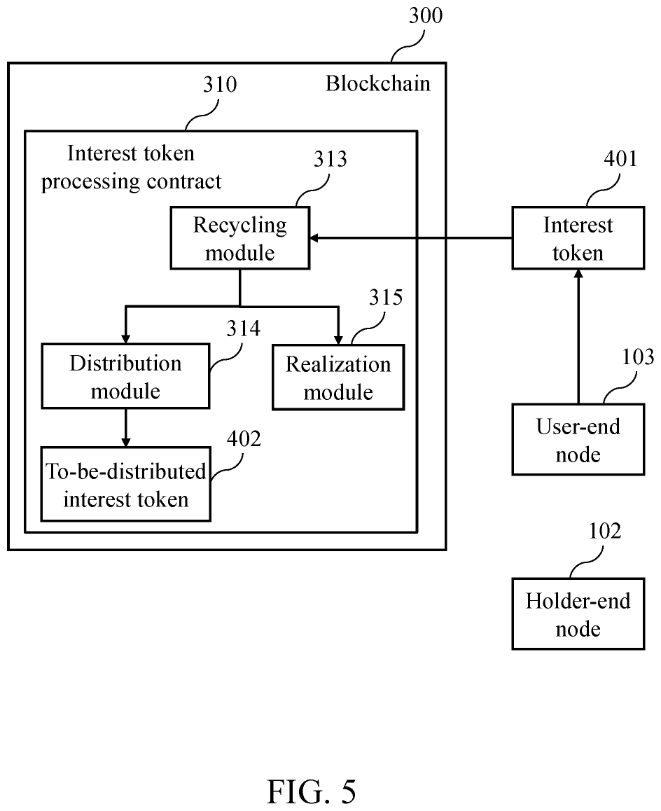

Please refer to FIG. 5, which is a schematic diagram of an operation of using interest tokens, according to an application of the present invention. When the holder-end node 102 wants to obtain the product or service, the holder-end node 102 becomes the user-end node 103 and executes the recycling module 313 to transfer the interest tokens 401 corresponding to the product or the service to an interest token processing contract 310. The recycling module 313 performs a recycling-and-splitting process on the interest tokens 401 based on the recycling condition, the recycling-and-splitting process executes at least one of the realization module 315 and the distribution module 314 based on the recycling condition. When the realization module 315 is executed, the realization module 315 destroys the received interest tokens 401; when the distribution module 314 is executed, the distribution module 314 continuously accumulates the received interest tokens 401 as the to-be-distributed interest token 402 for further distribution. In an embodiment, the recycling condition can include a ratio of the interest tokens for the splitting process, for example, 20% of the interest tokens 401 are for the distribution module 314, 80% of the interest tokens 401 are for the realization module 315, so the distribution module 314 can be executed first to accumulate 20% of the interest tokens 401, and the realization module 315 is then executed to destroy 80% of the interest tokens 401. In a condition that all of the interest tokens 401 are accumulated, only the distribution module 314 is executed to accumulate 100% of the interest tokens 401; in a condition that all of the interest tokens 401 are realized, only the realization module 315 is executed to destroy 100% of the interest tokens 401. In other words, besides the operation of accumulating or realizing all interest tokens 401, the recycling-and-splitting process does not realize all of the interest token 401, but accumulate the interest tokens 401 that is not realized, so as to perform interest distribution on the accumulated interest tokens 401 based on the preset ratio.

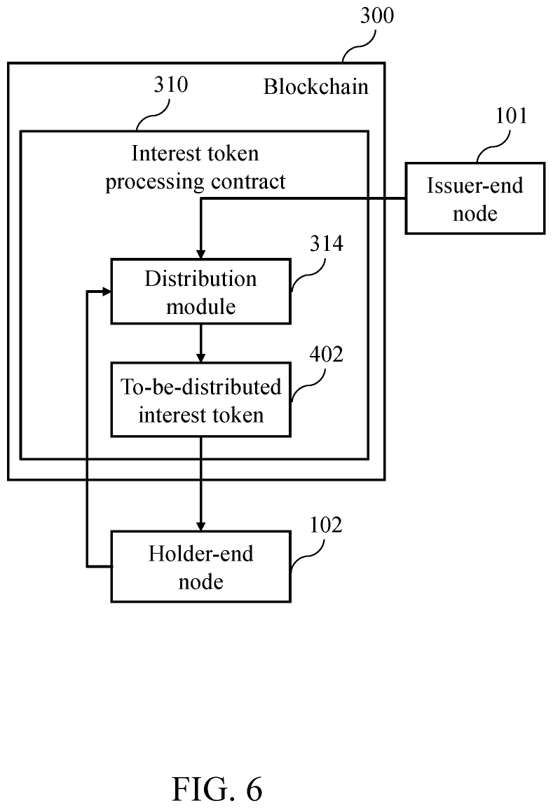

Please refer to FIG. 6, which is a schematic diagram of an operation of distributing interest tokens, according to an application of the present invention. In order to distribute the to-be-distributed interest tokens 402, the holder-end node 102 or the issuer-end node 101 can trigger the distribution module 314 based on the recycling condition, so that the distribution module 314 distributes the accumulated to-be-distributed interest tokens 402 to the holder-end node 102 based on a ratio of a held amount of the interest tokens to a current circulation amount of the interest tokens. In actual implementation, the condition set by the distribution module 314 can include that the holder-end node 102 holding more than a preset amount of tokens is permitted to trigger the distribution module 314, or only the specified target is permitted to execute the distribution module 314 within a specified time range (such as within 5 minutes); the condition can include the time interval for every distribution. The operation of distributing interest tokens is taken as example, in a condition that the amount of accumulated to-be-distributed interest tokens 402 is 100 and there are two holder-end nodes holding 400 and 500 interest tokens, respectively (that is, the total amount of the interest tokens 402 is 1000); the distribution module 314 distributes 40 interest tokens to the holder-end node holding 400 interest tokens and distributes 50 interest tokens to the holder-end node holding 500 interest tokens based on the ratio between the amounts of the interest tokens held by the two holder-end nodes. The remaining 10 interest tokens are reserved as the to-be-distributed interest tokens for further distribution. In practice, the number of executing the distribution module 314 is not limited to one, for example, the distribution module 314 can be executed for many times to implement periodic distribution.

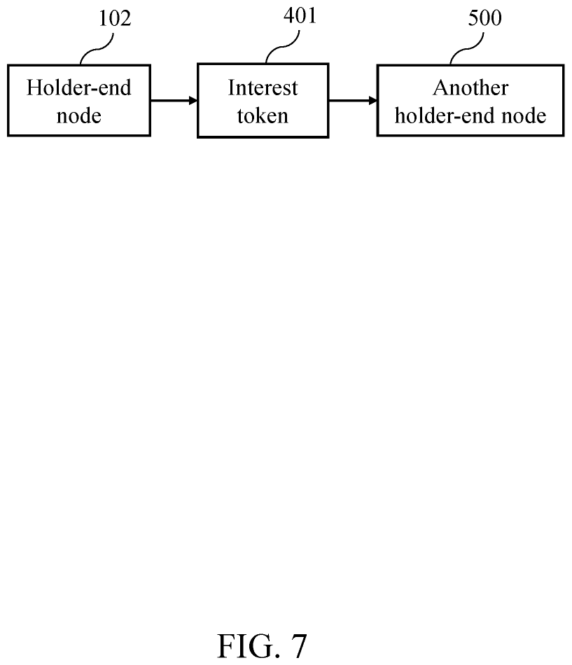

Please refer to FIG. 7, which is a schematic diagram of an operation of transferring interest tokens, according to an application of the present invention. In actual implementation, the amount of the holder-end node 102 can be one or multiple, for example, another holder-end node 500 can exist in the environment at the same time; in this case, the holder-end node 102 executes the transfer module 311 (as shown in FIG. 3) to transfer the interest token 401 from the holder-end node 102 to another holder-end node 500. The transfer operation can be performed at any time point after the interest tokens 401 are issued.

As described above, the present invention uses the recycling-and-splitting process to perform the usability and interest distribution of the interest tokens, and the present invention can be applied in different embodiments. The applications for different situations will be illustrated in the following paragraphs. First, the application of accounts receivable is taken as an example, the interest tokens are regarded as accounts-receivable tokens, for example, the product or the service has been delivered but the payment is received in installments. In this case, the interest token issuer is an entrusted issuer or an accounts receivable holder, and has an issuer-end node 101. The interest token holder can be any holder of the accounts-receivable tokens, and has a holder-end node 102; the initial interest token holder is the accounts-receivable holder, and the holder can freely transfer the accounts-receivable tokens. The interest token user is a payer (debtor) of the accounts receivable, and has a user-end node 103. The steps of whole process are as follows.

In a first step, the issuer-end node 101 manages the accounts-receivable interest token contract (that is, the interest token processing contract 310), and issues equity tokens (such as interest tokens) and delivers the equity tokens to the accounts receivable holder, based on entrustment of the accounts-receivable holder; for example, the equity tokens are transmitted to the holder-end node 102. When the total amount of accounts receivable is 50000, 50000 accounts-receivable tokens are issued based on the total amount.

In a second step, the issuer-end node 101 sets a recycling condition based on the content of an accounts receivable contract, the recycling condition includes that the total recycling amount is 1.1 times of accounts receivable amount (that is, the total recycling amount is 55000 interest tokens), a realization ratio is 90%, a distribution ratio is 10%, a time limit being 5 years in installments, and the payment in installments being 11000. The payer of the accounts receivable should perform the payment in installments through the recycling module.

In a third step, the user-end node 103 needs to obtain the accounts-receivable tokens for payment in installments, and the possible method of obtaining the accounts-receivable tokens includes purchase from the entrusted issuer or anyone who holds accounts-receivable tokens. When paying installments through the recycling module, the user-end node 103 should specify the recycling condition corresponding to the accounts receivable to indicate that the payment is for the installments of accounts receivable of a certain contract. The 11000 accounts-receivable tokens for this installment payment are split, by the recycling module, into a 90% part for the realization module, and a 10% part for the distribution module. The realization module destroys the 9900 accounts-receivable tokens to represent that the tokens are realized in value and removed from the token system. The distribution module accumulates the 1100 accounts-receivable tokens to be distributed to interest token holders.

In a fourth step, after the accounts-receivable token mechanism has been running for a period of time, the holder-end node 102 or the issuer-end node 101 can trigger the distribution module to distribute accumulated accounts-receivable tokens at an agreed time, such as, at 00:00 on January 1 every year. In a condition that the circulation amount (that is, the total issuance amount minus the total realization amount) of the accounts-receivable tokens at this time point is 1000000 and the amount of the accumulated interest tokens for distribution is 10000, 0.01 accounts-receivable tokens is distributed to 1 accounts-receivable token held by the holder; for example, 500 accounts-receivable token are distributed to the holder holding 50000 accounts-receivable tokens.

In this situation, the same entrusted issuer may receive entrustments from multiple accounts receivable holders, issue accounts-receivable tokens for multiple times and set various recycling conditions for multiple accounts receivable payers to pay through the corresponding recycling condition. The fourth step can be performed periodically after the first, second and third steps are performed one or more times. In addition, the process may also have a separate step, for example, after the initial accounts receivable holder issues the interest tokens and becomes the accounts-receivable token holder, the holder can freely transfer the accounts-receivable tokens to a buyer (like delivery of goods) in exchange for cash.

An embodiment of interest tokens of an intellectual property (IP) licensing contract is taken as an example. In this embodiment, an IP has been licensed but the payment is paid in installments during a licensing period, and the installments are an extension of accounts receivable. The equity token is an IP licensing token, such as interest token. An interest token issuer is an entrusted issuer or a licensor of the IP licensing contract and has the issuer-end node 101; an interest token holder is any holder of the IP licensing tokens and has the holder-end node 102, for example, the licensor of the IP licensing contract is the initial interest token holder and can freely transfer the IP licensing tokens; an interest token user is a licensee (that is, a paying party) of the IP licensing contract and has a user-end node 103. The steps of whole process of this embodiment are as follows.

In a first step, the issuer-end node 101 manages an IP licensing contract, and issues the IP licensing tokens and delivers the IP licensing tokens to the licensor of the IP licensing contract, based on entrustment of the licensor of the IP licensing contract. When the IP licensing receivable is 1 million dollars, 1 million IP licensing tokens are issued based on the IP licensing receivable.

In a second step, the issuer-end node 101 sets a recycling condition according to the content of the IP licensing contract; the recycling condition can include that the total recycling amount is 1.1 times of the total receivable; that is, the total recycling amount is 1.1 million IP licensing tokens, and the recycling condition can include that a realization ratio is 90%, a distribution ratio is 10%, the time limit is 20 years in installments, and each installment payment is 5,5000 tokens. The licensee of IP licensing contract should pay the licensing fee periodically through the recycling module.

In a third step, the user-end node 103 needs to obtain the IP licensing tokens for periodic payment, and the possible method of obtaining the IP licensing tokens includes purchasing from the entrusted issuer or any person holding the IP licensing tokens. When periodically paying the licensing fee through the recycling module, the user-end node 103 needs to specify the recycling condition corresponding to the IP licensing contract, to indicate that this payment is for the certain installment of the IP licensing contract. The recycling module splits the 55 thousand IP licensing tokens for installment payment into a 90% part for the realization module and a 10% part for the distribution module. The realization module destroys the 49,500 IP licensing tokens to indicate that the 49,500 IP licensing tokens are realized in value and removed from the token system. The distribution module accumulates the 5,500 IP licensing tokens to be distributed to the interest token holders.

In a fourth step, after the IP licensing token mechanism has been running for a period of time, the holder-end node 102 or the issuer-end node 101 can trigger the distribution module to distribute accumulated IP licensing tokens at an agreed time, such as at 00:00 on January 1 every year. In a condition that a circulation amount (that is, a total issuance amount minus a total realization amount) of the IP licensing tokens at this time point is 10 million and the amount of the accumulated interest tokens for distribution is 0.1 million, 0.01 IP licensing tokens is distributed to 1 IP licensing token held by the holder, for example, 1000 IP licensing tokens are distributed to the holder holding 0.1 million IP licensing tokens.

In this situation, the same entrusted issuer may receive entrustment from licensors of multiple IP licensing contracts, issue IP licensing tokens for multiple times and set a variety of recycling conditions, so that the multiple licensees of the IP licensing contracts can pay through their corresponding recycling conditions, respectively. The fourth step can be performed periodically after the first, second and third steps are performed one or more times. In addition, the process may also have a separate step, for example, after the licensor of the IP licensing contract issues the interest token and become the IP licensing token holder in initial, the holder can freely transfer the IP licensing tokens, for example, the holder can deliver the IP licensing token to the licensee as consuming points in exchange for cash.

An embodiment of contract liabilities (such as vouchers, gift certificates or membership points) is taken as an example. In this embodiment, an equity token is a voucher token (that is, the interest token). The interest token issuer is a voucher issuer (such as a department store) and has the issuer-end node 101; an interest token holder is any holder holding voucher tokens and has the holder-end node 102; an interest token user is a voucher consumer in the transaction and has the user-end node 103. The steps of whole process of this embodiment are as follows.

In a first step, the issuer-end node 101 manages a voucher equity token contract, issues the voucher tokens (such as 2 million voucher tokens) and delivers the voucher tokens to itself. Another step can be performed in cooperation with other legal compliance requirements, for example, 2 million dollars are put in trust.

In a second step, the issuer-end node 101 sets a recycling condition for a relevant appointed store or special counter according to the content of the contract. For example, the recycling condition can include a realization ratio of 95%, a distribution ratio of 5%, no specific upper payment limit or time limit. The voucher consumer of the appointed store should perform payment through the recycling module when using the voucher for payment, and specify the recycling condition corresponding to the appointed store.

In a third step, the user-end node 103 needs to obtain voucher tokens before using the voucher to purchase goods or service, and the possible method of obtaining voucher tokens include purchasing from the department store or anyone who holds voucher tokens. When consuming the voucher tokens through the recycling module, the user-end node 103 should specify the recycling condition corresponding to the store, to indicate that this payment is for consumption at the store. In a condition that the voucher consumer consumes 1000 voucher tokens in this consumption, these tokens will be split by the recycling module into a 95% part for the realization module and a 5% part for the distribution module. The realization module destroys 950 voucher tokens to represent that the voucher tokens are realized in value and removed from the token system. The distribution module accumulates 50 voucher tokens (that is, the to-be-distributed interest tokens) to be distributed to equity token holders.

In a fourth step, after the voucher token mechanism has been running for a period of time, the holder-end node 102 or the issuer-end node 101 can trigger the distribution module to distribute the accumulated artwork present value tokens at an agreed time, such as at 00:00 on January 1 every year. In a condition that the circulation amount (that is, a total issuance amount minus a total realization amount) of the voucher tokens at this time point is 10 million and the amount of the accumulated interest tokens for distribution is 0.5 million, 0.05 voucher tokens is distributed to each voucher token held by a holder; for example, 1,500 voucher tokens are distributed to a holder who holds 30000 voucher tokens.

In this situation, the same department store may issue the voucher tokens upon different business requirements for multiple times, and set various recycling conditions for various appointed stores, so that voucher consumers can perform payments based on the recycling conditions corresponding the appointed stores, respectively. The fourth step can be performed periodically after the first, second and third steps are performed one or more times. In addition, the process may also have a separate step, that is, after the initial voucher token holder (that is, the department store) issues the voucher tokens and becomes the holder of the voucher tokens, the holder can freely transfer the voucher tokens to a buyer (such as the voucher buyer) as delivery of goods in exchange for cash. The department store can calculate another interest distribution or cash settlement with the appointed stores based on the records and realization amounts of different recycling conditions.

An embodiment of the tokenization of current values of artworks is taken as an example, that is, the tokens can be recycled through the use and sale of an artwork. In this embodiment, an equity token is an artwork-present-value token (that is, the interest token). The interest token issuer is an art gallery that holds an artwork and has the issuer-end node 101; the interest token holder is a holder of artwork-present-value tokens and has the holder-end node 102; the interest token user is a consumer who rents or purchases the artwork, and has the user-end node 103. The overall steps of the process of this embodiment are as follows.

In a first step, the issuer-end node 101 manages the artwork-present-value token contract, issues the artwork-present-value tokens and delivers the artwork-present-value tokens to itself. For example, 5 million artwork-present-value tokens are issued for an artwork with a present value of 5 million dollars. Another step can be performed in cooperation with other legal compliance requirements, for example, the artwork is put in trust or mortgaged, or cash equal to the present value of the artwork is put in trust.

In a second step, the issuer-end node 101 sets a recycling condition for content of an artwork renting contract (that is, the artwork is rented for exhibition). For example, the recycling condition can include a realization ratio of 0%, a distribution ratio of 100%, a payable amount and a payable time. The payment may be performed in installments according to the exhibition period. The rental consumer should perform the rental payment through the recycling module and specify the recycling condition corresponding to the renting contract.

In a third step, the user-end node 103 needs to obtain the artwork-present-value tokens for rental payment, and the possible method of obtaining the artwork-present-value tokens can include purchasing from the gallery or anyone who holds the artwork-present-value tokens. When paying artwork-present-value tokens through the recycling module, the user-end node 103 should specify the recycling condition corresponding to the renting contract, to indicate that this payment is for execution of the renting contract. In a condition that the consumer renting the artwork pays 0.1 million artwork-present-value tokens for rent, 100% of these tokens will be transmitted to the distribution module by the recycling module. The realization module does not destroy any artwork-present-value tokens to represent that the artwork-present-value are not removed from the token system. The distribution module accumulates 0.1 million artwork-present-value tokens (that is, the to-be-distributed interest tokens) to be distributed to equity token holders.

In a fourth step, after the artwork-present-value token mechanism has been running for a period of time, the equity token holders or the gallery can trigger the distribution module to distribute the accumulated artwork-present-value tokens at an agreed time, such as at 00:00 on January 1 every year. In a condition that a circulation amount (that is, a total issuance amount minus a total realization amount) of the artwork-present-value tokens at this time point is 10 million and the amount of the accumulated interest tokens for distribution is 0.5 million, 0.05 artwork-present-value tokens is distributed to each artwork-present-value token held by a holder; for example, 1500 artwork-present-value tokens are distributed to a holder who holds 30000 artwork-present-value tokens.

In this situation, the same gallery may issue artwork-present-value tokens for different artworks for multiple times, the amount of the tokens issued at different time can be determined by different valuation of the artwork. Various recycling conditions can be set for various transaction scenarios, for example, when the transaction scenario is the artwork renting contract, the value of the artwork is not removed from the token system, so the realization ratio is 0%, all the rental income (that is, 100% income) is accumulated and distributed; when the transaction scenario is sale of artworks, the value of artworks is removed from the system, so the realization ratio can be a ratio of the initial issuance amount to the selling price, that is, the original issued tokens are realized, and additional interest is distributed, for example, an amount of the original issued tokens is 5 million and the price is 6 million dollars, and the amount of the tokens to be realized is still 5 million. The renter and buyer of the artwork should perform payment based on the corresponding recycling condition. The fourth step can be performed periodically after the first, second and third steps are performed one or more times. In addition, the process may also have a separate step, for example, after the initial artwork-present-value token holder (that is, the gallery or the artwork author) issues the artwork-present-value tokens and becomes the holder of the artwork-present-value tokens, the holder can freely transfer the artwork-present-value tokens to a buyer (such as an artwork renter or buyer) in exchange for cash. The issuer-end node 101 representing the gallery can calculate other interest distribution or cash settlement based on the records and realization amounts of different recycling conditions.

According to above-mentioned content of the present invention, the difference between the present invention and the conventional technology is that, in the present invention, the smart contract is deployed in the blockchain environment, and the interest tokens of the product or the service and the recycling condition of the interest tokens are generated for the specified target; when the product or the service is obtained through the interest tokens, the smart contract is executed to realize a part of the interest tokens based on the recycling condition and receive another part of the interest tokens for further distribution; during an operation of further distribution, the received interest tokens are distributed based on the ratio of the held amount of the interest tokens to the circulation amount of the interest tokens. Therefore, the above-mentioned solution of the present invention is able to solve the convention problem, so as to achieve the technical effect of enabling the tokens to have usability and interest right.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. An interest token processing system integrated with a blockchain, wherein the interest token processing system is applied to blockchain environment where node hosts are disposed, each of the node hosts has a wallet address as node identification and has the ability to access a blockchain wallet according to the wallet address, and the interest token processing system comprises:
an issuer-end node, wherein the issuer-end node is one of the node hosts, and the issuer-end node is configured to deploy an interest token processing contract in the blockchain environment, the interest token processing contract comprises a transfer module, an issuance module, a recycling module, a distribution module and a realization module executed by a processor, and the issuer-end node executes the issuance module to generate at least one interest token corresponding to a product or a service, and executes the recycling module to set a recycling condition of the interest token;
a holder-end node, wherein the holder-end node is one of the node hosts, and the holder-end node is configured to hold the interest token; and
a user-end node, wherein the user-end node is one of the node hosts, and when the user-end node wants to obtain the product or the service, the user-end node executes the recycling module to transfer the interest token corresponding to the product or service to the interest token processing contract, wherein the recycling module performs a recycling-and-splitting process on the interest token based on the recycling condition, the recycling-and-splitting process executes at least one of the realization module and the distribution module based on the recycling condition, when the realization module is executed, the realization module destroys the received interest token, wherein when the distribution module is executed, the distribution module continuously accumulates the received interest token as a to-be-distributed interest token for further distribution;
wherein when wanting to distribute the to-be-distributed interest token, the holder-end node or the issuer-end node triggers the distribution module based on the recycling condition, so that the distribution module distributes the accumulated to-be-distributed interest token to the holder-end node based on a ratio of a held amount of the at least one interest token to a current circulation amount of the at least one interest token.

2. The interest token processing system integrated with blockchain according to claim 1, wherein when the issuer-end node generates the interest token, the issuer-end node is permitted to set a specified amount and a specified target, to transmit the specified amount of the at least one interest token to the specified target, to make the specified target become the holder-end node.

3. The interest token processing system integrated with blockchain according to claim 1, wherein the holder-end node executes the transfer module to transfer the interest token to another host in the blockchain environment.

4. The interest token processing system integrated with blockchain according to claim 1, wherein the distribution module comprises a time interval for every distribution, the distribution module is permitted to be executed by the holder-end node which holds the interest token of an amount satisfying a preset value, or the distribution module is permitted to be only executed by a specified target within a specified time range.

5. The interest token processing system integrated with blockchain according to claim 1, wherein the issuer-end node or the user-end node becomes the holder-end node when holding the interest token.

6. An interest token processing method integrated with a blockchain, wherein the interest token processing method is applied to blockchain environment where node hosts are disposed, each of the node hosts has a wallet address as node identification and has the ability to access a blockchain wallet according to the wallet address, and the interest token processing method comprises:
providing an issuer-end node, a holder-end node and a user-end node as the node hosts in the blockchain environment, and deploying an interest token processing contract in the blockchain environment, wherein the interest token processing contract comprises a transfer module, an issuance module, a recycling module, a distribution module and a realization module executed by a processor;
executing the issuance module to generate at least one interest token corresponding to a product or a service, transmitting the interest token to the holder-end node, and executing the recycling module to set a recycling condition of the interest token, by the issuer-end node;
when the holder-end node wants to obtain the product or the service, making the holder-end node become the user-end node to execute the recycling module to transfer the interest token corresponding to the product or the service to the interest token processing contract, wherein the recycling module performs a recycling-and-splitting process on the interest token based on the recycling condition, the recycling-and-splitting process executes at least one of the realization module and the distribution module based on the recycling condition, wherein when the realization module is executed, the realization module destroys the received interest token, wherein when the distribution module is executed, the distribution module continuously accumulates the received interest token as a to-be-distributed interest token for further distribution; and
in order to distribute the to-be-distributed interest token, triggering the distribution module based on the recycling condition, by the holder-end node or the issuer-end node, wherein the distribution module distributes the accumulated to-be-distributed interest token to the holder-end node based on a ratio of a held amount of the at least one interest token to a current circulation amount of the at least one interest token.

7. The interest token processing method integrated with blockchain according to claim 6, wherein when the issuer-end node generates the interest token, the issuer-end node is permitted to set a specified amount and a specified target, to transmit the specified amount of the at least one interest token to the specified target, to make the specified target become the holder-end node.

8. The interest token processing method integrated with blockchain according to claim 6, wherein the holder-end node executes the transfer module to transfer the interest token to another host in the blockchain environment.

9. The interest token processing method integrated with blockchain according to claim 6, wherein the distribution module comprises a time interval for every distribution, the distribution module is permitted to be executed by the holder-end node which holds the interest token of an amount satisfying a preset value, or the distribution module is permitted to be only executed by a specified target within a specified time range.

10. The interest token processing method integrated with blockchain according to claim 6, wherein the issuer-end node or the user-end node becomes the holder-end node when holding the interest token.
